(19) United States
(12) Patent Application Publication
(10) Pub. No.: US 2023/0110605 A1
(43) Pub. Date: Apr. 13, 2023

(54) Socket Security and Authentication Device, System and Method

(71) Applicant: SnowShoeFood Inc., Portland, OR (US)

(72) Inventors: Ned Dykstra Hayes, Portland, OR (US); Charles Alan McAllister, Portland, OR (US)

(73) Assignee: SnowShoeFood Inc., Portland, OR (US)

(21) Appl. No.: 17/962,535

(22) Filed: Oct. 9, 2022

Related U.S. Application Data
(60) Provisional application No. 63/254,453, filed on Oct. 11, 2021.

(51) Int. Cl. H04L 9/40

(52) U.S. Cl. CPC H04L 63/0853; H04L 63/123

(57) ABSTRACT

A socket security and authentication device is disclosed that has a socket configured to receive a verification module or plug, where the verification module or plug may include, but is not limited to, RFID and Near Field Communications (NFC), QR codes, bar codes, bluetooth communications, magnetic stripe, magnetic memory, fingerprint and biometric identification, as well as capacitively patterned stamps and devices. The socket may have a cradle for receiving and retaining the verification module or plug. The socket may also have a shell for mechanical retention as well as aesthetics.

### CROSS REFERENCE TO RELATED PATENT APPLICATIONS

This application claims priority to U.S. Patent Application Ser. No. 61/254,453 filed Oct. 11, 2021 entitled “Socket Security and Authentication Device, Systems and Method”, the entire disclosure of which is incorporated herein by reference in its entirety.

### FIELD OF THE INVENTION

The present invention relates generally to security, authentication, verification and validation, and more particularly to a Socket Security and Authentication Device, System and Method.

### BACKGROUND OF THE INVENTION

Security, validation, authentication and verification for a variety of purposes including, but not limited to, security, event entry and exit, retail transactions, check in at stores, airports, universities, and the like is commonly done by way of either personnel or technology, Technologies employed for such purposes include RFID and Near Field Communications (NFC), QR codes, Bluetooth beacon, bar codes, magnetic stripe cards, punch cards, loyalty cards, fingerprint and biometric authentication, as well as capacitively patterned stamps and devices. Capacitively patterned devices and stamps are described, for example, in U.S. Pat. No. 9,152,279 to Moberg et al. and entitled “Tool And Method For Authenticating Transactions” and U.S. Pat. No. 9,298.907 to Moberg et al. and entitled “Methods For Enabling Real-Time Digital Object And Tangible Object Interactions”, and are both incorporated by reference herein in their entirety, as permissible by national or regional laws.

Security, validation, authentication and verification may be done for entry to an event, such as an entertainment event, for payment purposes, for identification and security, and the like. In addition, a retail or business establishment may require check-in or verification for a variety of business purposes. The most basic form of validation and authentication is printed paper, such as a paper ticket, paper punch card, etc. As technology has advanced and the need for anti-counterfeiting has grown, advancements such as magnetically encoded strips, radiofrequency identification elements, bar codes, QR codes, and other such elements have become commonplace, as these elements are oftentimes embedded or otherwise integrated into a card, ticket, or a similar validation or authentication device.

While using a specific technology for a specific purpose is currently being done, there remains a need to support multiple or varied security, validation, authentication and verification technologies. Further, as technology and related computing and software systems evolve and change, there is an unmet need to evolve and change the security, validation, authentication and verification technology without changing the encompassing business process, display or fixture, or other such operating environment. For example, if a retail business uses a fixed in place QR code as part of an in store display and the business needs evolve such that the fixed in place QR code is no longer adequate for providing the customer with product and pricing information, there remains an unmet need to change the fixed QR code to another technology (for example, a capacitively patterned device) while maintaining the fixturing present in the store related to that particular display. Further, with ongoing security problems related to any given technology, there remains an unmet need to combine multiple authentication technologies or to change out authentication technologies to support enhanced security techniques.

The present invention and the various embodiments described and envisioned herein address these heretofore unmet needs.

### SUMMARY OF THE INVENTION

In accordance with the present invention, there is provided a socket security and authentication device that comprises a socket configured to receive a verification module, where the verification module may include, but is not limited to, RFID and Near Field Communications (NFC), QR codes, bar codes, Bluetooth communications, magnetic stripe, magnetic memory, fingerprint and biometric identification, as well as capacitively patterned stamps and devices. In some embodiments, the socket comprises a cradle for receiving and retaining the verification module. The socket may also, in some embodiments, have a shell for mechanical retention, aesthetics, and the like.

The foregoing paragraph has been provided by way of introduction, and is not intended to limit the scope of the invention as described herein.

### BRIEF DESCRIPTION OF THE DRAWINGS

The invention will be described by reference to the following drawings, in which like numerals refer to like elements, and in which;

FIG. 1 depicts an exploded view of the socket security and authentication device of the present invention;

FIG. 2 depicts an alternate exploded view of the socket security and authentication device of the present invention;

FIG. 3 depicts a side plan view of the socket security and authentication device of the present invention with a cross sectional view taken along line A-A;

FIG. 4 depicts an alternate side plan view of the socket security and authentication device of the present invention with a cross sectional view taken along line B-B;

FIG. 5 depicts a side plan view of the socket security and authentication device of the present invention;

FIG. 6 depicts an alternate side plan view of the socket security and authentication device of the present invention;

FIG. 7 depicts a top plan view of the socket security and authentication device of the present invention;

FIG. 8 depicts a bottom plan, view of the socket security and authentication device of the present invention;

FIG. 9 depicts a top perspective view of the socket security and authentication device of the present invention;

FIG. 10 depicts an alternate top perspective view of the socket security and authentication device of the present invention; and

FIG. 11 depicts the socket security and authentication device of the present invention in use.

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification, claims and drawings attached hereto.

### DESCRIPTION OF THE PREFERRED EMBODIMENTS

A socket security and authentication device and related methods and systems are disclosed. The socket security and authentication device comprises a socket configured to receive a verification module, where the verification module may include, but is not limited to, RFID and Near Field Communications (NFC), QR codes, bar codes, bluetooth communications, magnetic stripe, magnetic memory, as well as capacitively patterned stamps and devices. The socket of the device may comprise a cradle or other such fixturing for receiving and retaining the verification module. The socket or the overall socket security authentication device may also, in some embodiments, have a shell for mechanical retention, aesthetics, and the like.

The present invention includes a componentized verification system that can case a multiplicity of verification factors, each of which can be “plugged into” a socket or cradle that is fixed in place at a retail or business establishment. This socket can support a variety of verification or check in technology components, such as a unique pattern identification system that is used with capacitive touch screens on smart phones, fingerprint and biometric sensors, near field (RFID) components, Bluetooth beacon technologies, QR and other printed codes, and the like. Each of these technologies can serve as a “plug” for the unique socket or cradle that may be a small square or round form factor with a hollow body that can accommodate a variety of “verification plugs or modules” that can be placed in the body of the socket. The socketized nature of this verification technology is a novel aspect of the present invention. The socket can be fixed at a retail establishment, can be fixed to a lanyard, can include NFC to identify what plug is in the socket, can be attached to power or combined with other technologies, and the like.

The socket may be combined with verification or other software and there may even be a process to certify the verification plugs or modules that are used in the novel socket of the present invention.

U.S. Pat. No. 9,152,279 to Moberg et al, entitled “Tool And Method For Authenticating Transactions”, U.S. Pat. No. 9,298,907 to Moberg et al, and entitled “Methods For Enabling Real-Time Digital Object And Tangible Object Interactions” and U.S. Pat. No. 11,328,046 B2 to Worley et al. and entitled “Embedded Trace Capacitive Signet Stamp” are each incorporated by reference herein in their entirety.

A system of the present invention includes at least one embodiment of the Socket Security and Authentication Device as well as at least one method for authentication on an electronic device, as further described herein.

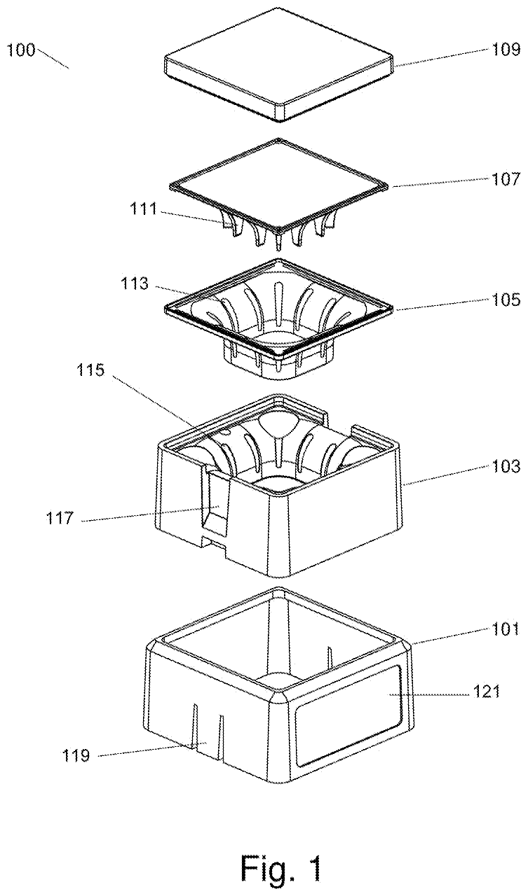

Turning now to the drawings, FIG. 1 depicts an exploded view of an example of a socket security and authentication device 100 in accordance with the present invention.

The socket security and authentication device 100 (the various components thereof) may be imide from a material such as a plastic or a metal. Examples of suitable plastics include melamine, polypropylene, polyvinyl chloride, polytetrafluoroethylene, silicone, other plastic or plastic-like materials, and the like. Bioplastics may also be used in some embodiments of the present invention. In addition, reinforced plastics, conductive plastics, metals, and other materials that may be suitably formed may also be used. The components of the socket security and authentication device 100, as seen for example in the exploded view of FIG. 1, may be made by injection molding, blow molding, machining, or the like. Additional components, such as, but not limited to, fixturing, attachments, anchors, displays, pedestals, and the like, may also be incorporated and employed in the present invention.

The exploded view depicted in FIG. 1 depicts a cradle 103 as a rectangular shaped socket or receptacle. In some embodiments of the present invention, the cradle 103 may be round, oval, octagonal, or other suitable geometry. The cradle 103 is configured to receive a verification module (in this example the top cap 105 and the charge transfer element 107 comprise the verification module). The cradle or socket 103 is configured to receive a verification module such as a unique pattern identification system that is used with capacitive touch screens on smart phones, fingerprint and biometric sensors, near field (RFID) components, Bluetooth beacon technologies, QR and other printed codes, and the like. In the case of a unique pattern identification system (for example, as described in U.S. Pat. No. 9,152,279 to Moberg et al. and entitled “Tool And Method For Authenticating Transactions”, U.S. Pat. No. 9,298,907 to Moberg et al. and entitled “Methods For Enabling Real-Time Digital Object And Tangible Object Interactions”, and U.S. Pat. No. 11,328,046 B2 to Worley et al. and entitled “Embedded Trace Capacitive Signet Stamp” the entire disclosures of which are incorporated herein by reference) the cradle or socket 103 has a conductive inner lining or structure to facilitate charge transfer. The conductive inner lining as seen in FIG. 1 has a curvilinear surface with a series of cradle slits 115, apertures or openings that receive conductive spines 111 protruding from the charge transfer element 107. The conductive inner lining and the conductive spines may be made from a conductive plastic or other conductive material. Surrounding the cradle or socket 103 is a shell 101 that serves to both retain the overall device as well as provide a cosmetically appealing appearance. The cradle 103 also may have a tab recess 117 that accommodates, in some embodiments of the present invention, a tab 119 on the shell 101 that serves to retain the shell 101 to the cradle 103. A top cap 105 can be seen with a series of top cap slits 113 or apertures to receive the conductive spines 111 of the charge transfer element 107. The charge transfer element 107 is thus inserted in the top cap 105 which is in turn inserted in the cradle 103. The charge transfer element 107 is conductive, and may be made from, for example, a conductive plastic. The charge transfer element 107 transfers charge to a unique pattern of points on base plate 109 for recognition by a touch screen of an electronic device. A base plate 109 can be seen that contains conductive points that make up a uniquely identifiable pattern that can be read by a capacitive touch screen and related software. In some embodiments of the present invention, the conductive points are aluminum points that are affixed, printed, or otherwise attached to the base plate 109. The unique pattern of conductive points that are laid out on the base plate 109 are not readily evident in FIG. 1, as the unique pattern of conductive points may be covered by a protective layer such as a protective layer of plastic, vinyl, or the like. The protective layer serves to protect or shield the visibility of the unique pattern of conductive points, and may also serve to retain or otherwise mechanically bond the conductive points to the base plate 109. The unique pattern of conductive points may be deposited on a substrate such as a plastic, ceramic, paper or cardboard substrate using a conductive ink. In other embodiments the unique pattern of conductive points may be machined, affixed with an adhesive, or the like. The conductive points are arranged in a unique pattern that is specific to that a verification module and is recognized by a touch screen of an electronic device as a unique pattern thereof. The conductive points are electrically connected through conductive traces that may be printed using conductive ink, adhered to or otherwise machined or manufactured. The conductive traces connect the conductive points to the charge transfer element 107 or similar source or sink of electrical charge to provide the necessary capacitive interaction required to activate and apply touch screen functionality of the electronic device. Unique patterns of conductive points are further described in U.S. Pat. No. 9,152,279 to Moberg et al, and entitled “Tool And Method For Authenticating Transactions”, U.S. Pat. No. 9,298,907 to Moberg et al. and entitled “Methods For F. Enabling Real-Time Digital Object And Tangible Object Interactions”, and U.S. Pat. No. 11,328,046 B2 to Worley et al. and entitled “Embedded Trace Capacitive Signet Stamp” the entire disclosures of which are incorporated herein by reference. The protective layer may also contain product branding, instructions, advertising, or even lighting. The various components described and depicted in FIG. 1 are assembled and retained by a variety of techniques such as, but not limited to, friction fitting, adhesives, mechanical coupling, mechanical fastening, and the like. While the socket security and authentication device is depicted as having a square geometry, other shapes and forms may also be employed. The socket security and authentication device may be cylindrical, rectangular, octagonal, hexagonal, of an organic or curvilinear shape, or the like. The socket security tract authentication device may also be integrated with, or built into, other structures such as pedestals, displays, entry gates, doors or door frames, posts, pillars, and the like.

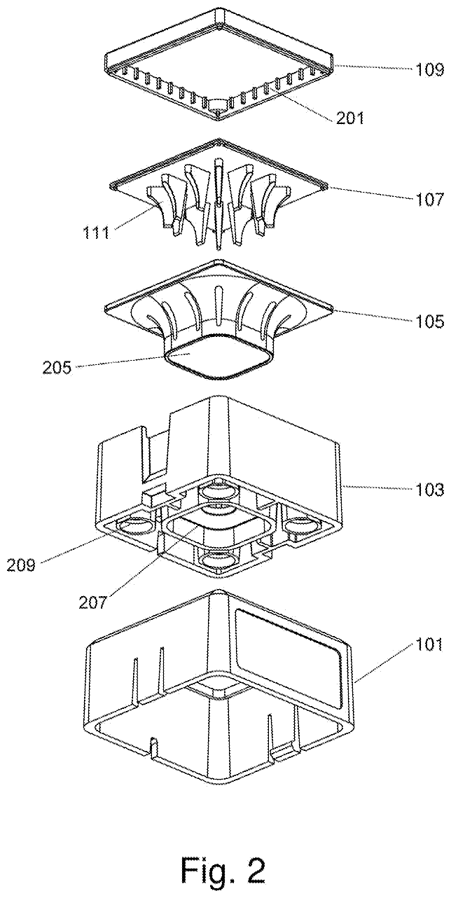

It should also be noted that in the example depicted in FIG. 1, the verification module is a conductive touch pattern device that comprises a charge transfer element 107 and a top cap 105 that is received in a cradle 103. Other types of verification modules may be received by the cradle 103 that include, but are not limited to, fingerprint and biometric sensors, near field (RFID)) components, Bluetooth beacon technologies, QR and other printed codes, and the like. Regardless of the verification module, the basic approach of a verification module haying a plug and a cradle having a socket is maintained. The plug and socket arrangement is further described below and is seen more explicitly FIG. 2.

FIG. 2 depicts an alternate exploded view of the socket security and authentication device of the present invention showing more of the underside of each component that makes up the socket security and authentication device. The underside of the cradle 103 shows optional recesses or fasteners that may contain, for example, magnets to adhere the socket security and authentication device to a ferromagnetic structure. In addition to magnets, hook and loop fasteners, adhesive, and the like may be used. Ridges 201 or similar structures on the underside of the base plate 109 are used to frictionally engage with the charge transfer element 107. In this example, a plurality of protruding ridges 201 can be seen around the inner periphery of the base plate 109. The top cap 105 can be seen having a plug geometry 205 where the cradle 103 can be seen having a socket geometry 207 such that the top cap 105 and the charge transfer element 107 form the basis for a verification module that is in turn plugged into a socket 207 that is part of a cradle 103.

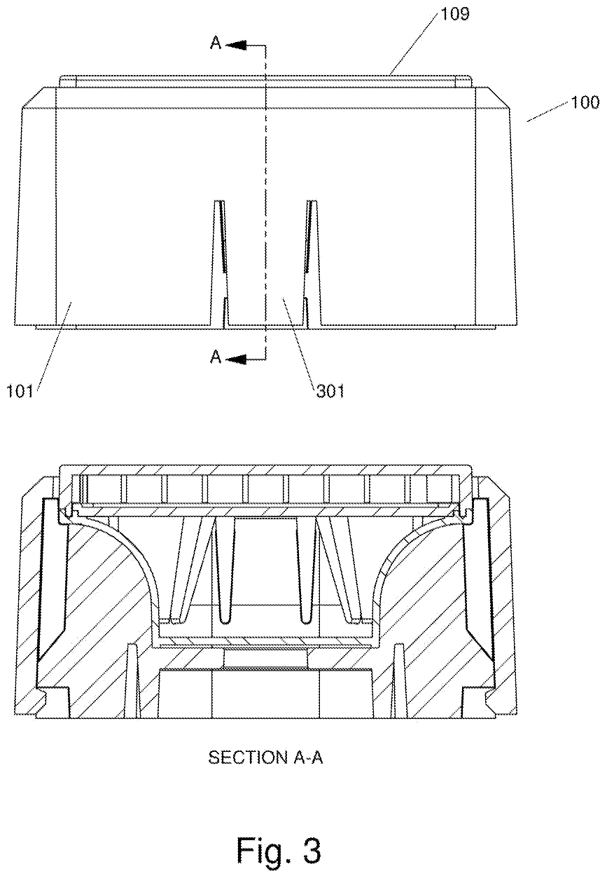

FIG. 3 depicts a side plan view of the socket security and authentication device of the present invention with a cross sectional view taken along line A-A. A tab 301 can be seen on the shell 101 that engages with a recess on the cradle to facilitate proper engagement and coupling of the shell 101 and the cradle 103.

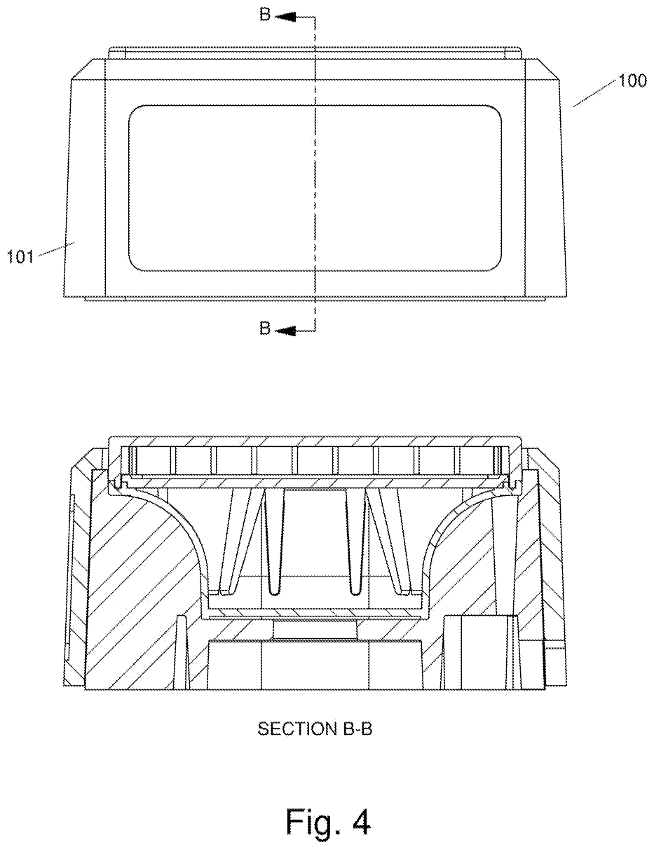

FIG. 4 depicts an alternate side plan view of the socket security and authentication device of the present invention with a cross sectional view taken along line B-B. A recess can be seen on the shell 101 that may contain advertising, a logo, instructions, graphics, or the like.

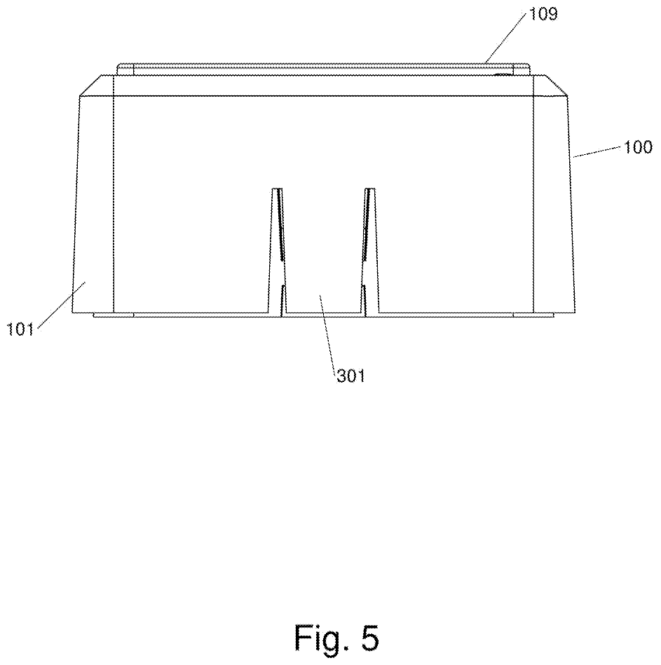

FIG. 5 depicts a side plan view of the socket security and authentication device of the present invention. The base plate 019 can be seen affixed to the charge transfer element 107 that is in turn coupled with the top cap 105 and retained by the cradle 103 which is surrounded by the shell 101. The tab 301 of the shell 101 can also be seen in FIG. 5.

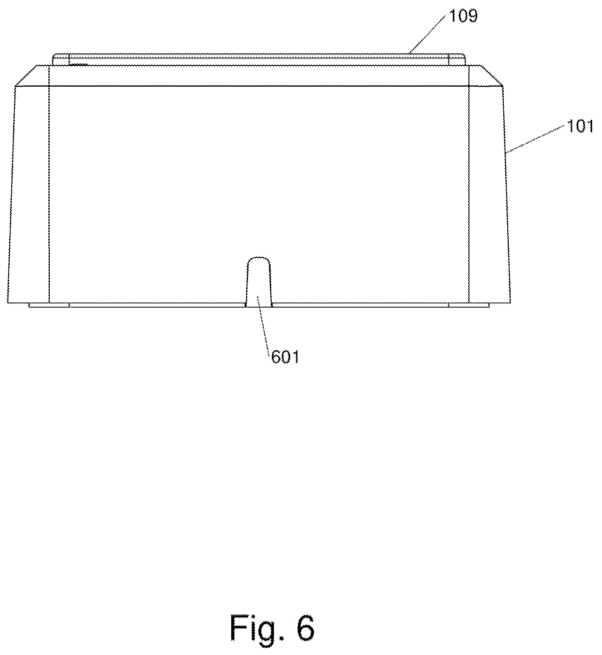

FIG. 6 depicts an alternate side plan view of the socket security and authentication device of the present invention. A slot 601 can be seen in the shell 101 where a tether may pass there through.

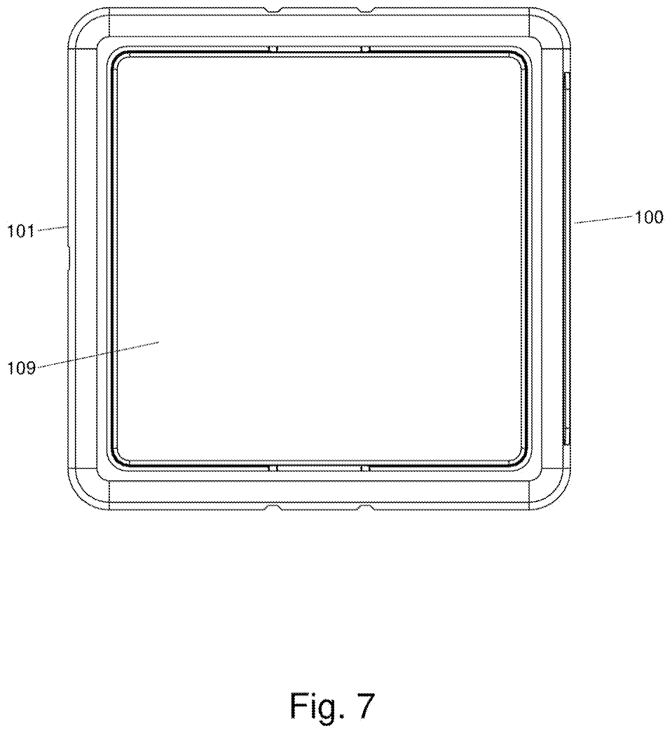

FIG. 7 depicts a top plan view of the socket security and authentication device 100 of the present invention. The base plate 109 can be seen covered by a protective layer such that the unique pattern of conductive points is not visible.

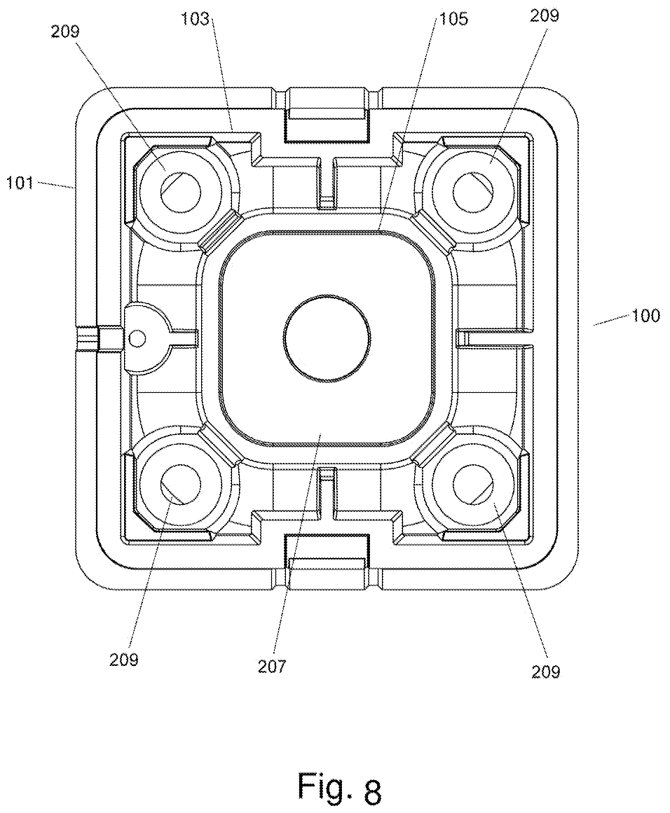

FIG. 8 depicts a bottom plan view of the socket security and authentication device of the present invention. In addition to the circular spaces for magnets at each corner, a tether point can be seen on the left hand side of FIG. 8 where a tether may be placed and guided through the slot 601 in the shell 101.

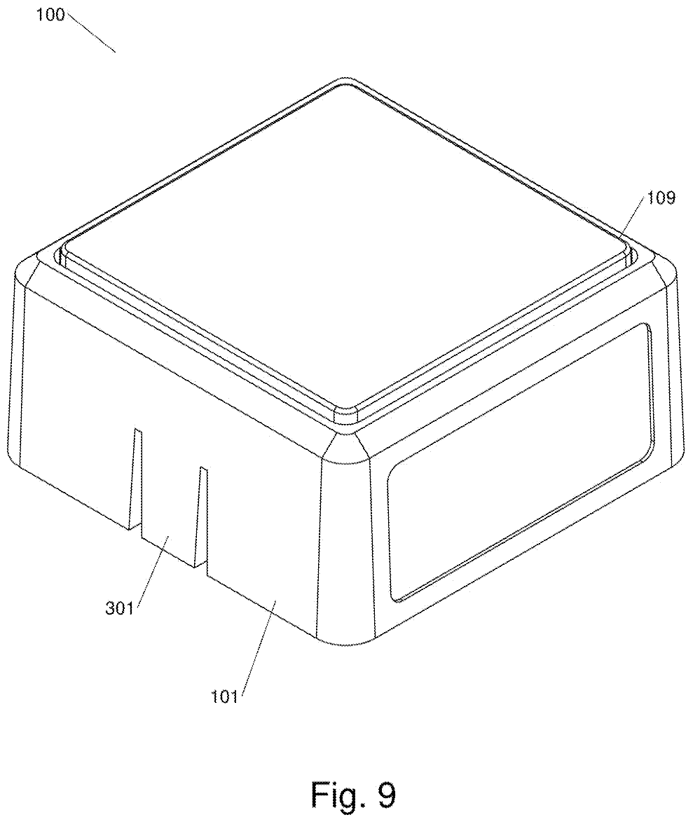

FIG. 9 depicts a top perspective view of the socket security and authentication device of the present invention. The base plate 109 can be seen with the shell 101 encompassing the inner components of the socket security and authentication device.

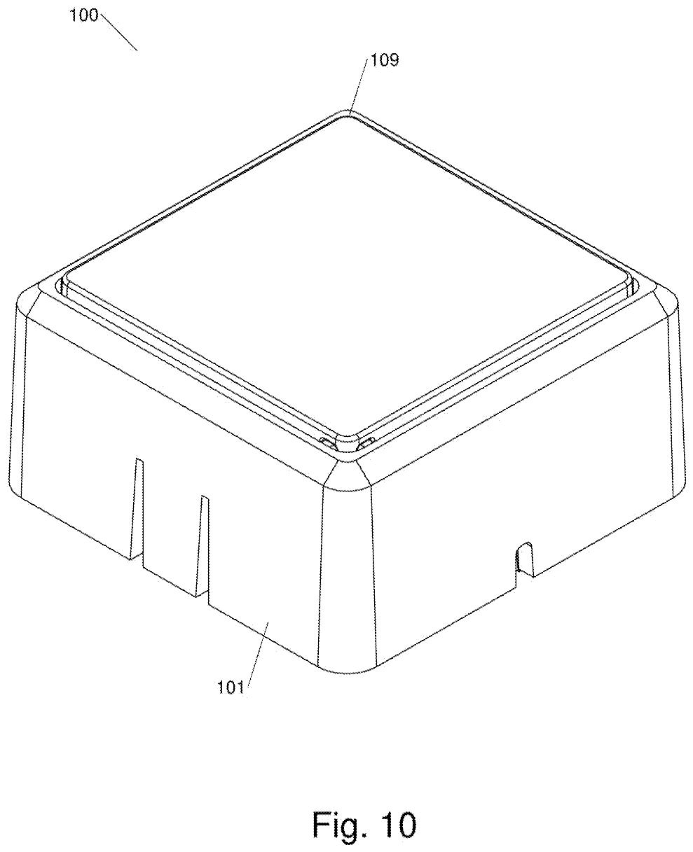

FIG. 10 depicts an alternate top perspective view of the socket security and authentication device of the present invention also showing the base plate 109 with the shell 101.

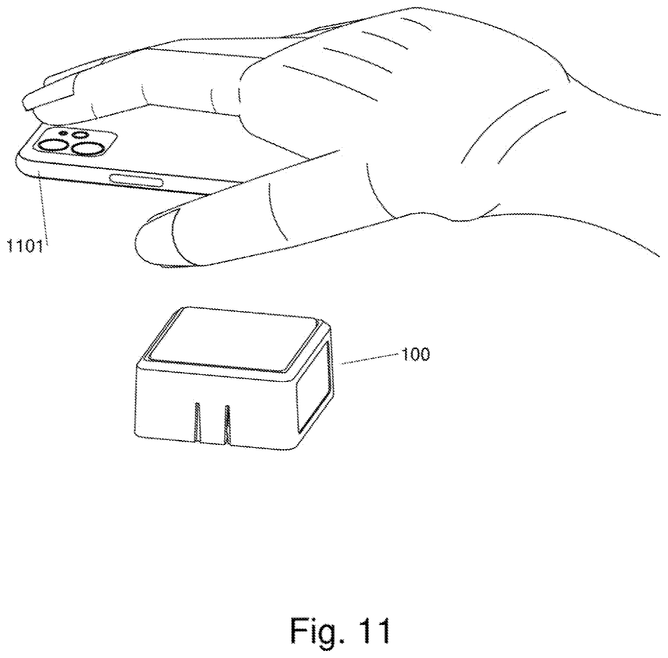

Lastly, FIG. 11 depicts the socket security and authentication device of the present invention in use. A user grasps their electronic device (such as a smartphone 1101) and places the touch screen in close proximity to the socket security and authentication device of the present invention. The verification module interacts with the electronic device to provide a unique signal or code to the electronic device for further processing by a software program that may reside on the electronic device or at a remote lactation (“the cloud” for example).

In use, the socket security and authentication device 100 may be affixed to a counter table, entryway, or the like. A user makes contact with the surface of the device (the base plate area 109) with a touch screen electronic device. The unique pattern of conductive points is read by the electronic device such that an action is taken. The action may include verification or authentication within a software program that may be resident, partially resident, or remote from, the electronic device. Additional or alternative verification technologies may also be used and may, in some embodiments, have a plug such as the plug 205 that can be inserted in the socket 207, thus providing interchangeability of authentication and security.

The present invention includes methods for security and authentication using the device of the present invention. Such methods use the unique verification or authentication code provided by the socket security and authentication device to facilitate activities such as entry to an event, for example an entertainment event, for payment purposes, for identification and security, and the like. In addition, a retail or business establishment may require check-in or verification for a variety of business purposes.

Methods of the present invention include, but are not limited to, authentication of a socket security and authentication device and a user. For example, a method for authentication on an electronic device having a capacitive touch sensor and a display may comprise detecting, on the capacitive touch sensor, the socket security and authentication device and authenticating, on a computer having a processor, memory and access to computer readable media, data associated with the socket security and authentication device and a user of the electronic device. The method may optionally include the step of providing on the display of the electronic device a message containing user instructions, and my also optionally provide authentication data generated from the method for authentication. Often, an action is taken based on the outcome of this authentication method such as, for example, entry to a building or a venue, application of a discount code, entry of user information for purposes of marketing or retail, and the like.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and drawings appended herein.

What is claimed is:

1. A socket security and authentication device comprising a cradle having a socket and configured to receive a verification module;
a verification module containing verification technology and having a plug, the plug adapted to be received by the socket.

2. The socket security and authentication device of claim 1, further comprising a shell that conforms to and covers the cradle.

3. The socket security and authentication device of claim 1, further comprising a fastener attached to the cradle for mounting the cradle to a surface.

4. The socket security and authentication device of claim 1, wherein the verification module comprises a unique pattern of conductive points adapted to interact with a touch screen of an electronic device.

5. The socket security and authentication device of claim 1, wherein the unique pattern of conductive points is affixed to a base plate that is electrically connected to a charge transfer element that is mechanically coupled to a top cap.

6. The socket security and authentication device of claim 5, wherein the charge transfer element comprises a plurality of conductive spines that interact with as plurality of top cap slits contained in a top cap.

7. The socket security and authentication device of claim 6, wherein the cradle comprises a plurality of cradle slits configured to receive the conductive spines of the charge transfer element through the top cap slits of the top cap.

8. The socket security and authentication device of claim 5, wherein the unique pattern of conductive points of the verification module is covered with a protective layer.

9. The socket security and authentication device of claim 6, wherein the conductive spines have a curved edge that conforms with the top cap slits and the cradle slits.

10. The socket security and authentication device of claim 1, wherein the verification module comprises RFID.

11. The socket security and authentication device of claim 1, wherein the verification module comprises Bluetooth authentication.

12. The socket security and authentication device of claim 1, wherein the verification module comprises a printed code.

13. The socket security and authentication device of claim 1, wherein the printed code is a QR code.

14. A socket security and authentication device comprising a cradle having a socket and configured to receive a verification module;
a verification module comprising a unique pattern of conductive points electrically coupled to a charge transfer element; and
a top cap mechanically coupled to the charge transfer element.

15. The socket security and authentication device of claim 14, wherein the charge transfer element comprises a plurality of conductive spines and where the top cap comprises a plurality of top cap slits configured to receive the plurality of conductive spines.

16. The socket security and authentication device of claim 14, wherein the cradle comprises a plurality of cradle slits configured to receive the plurality of conductive spines protruding through the top cap slits of the top cap.

17. A method for authentication on an electronic device having a capacitive touch sensor and a display, the method comprising;
detecting, on the capacitive touch sensor, the socket security and authentication device of claim 1;
authenticating, on a computer having a processor, memory and access to computer readable media, data associated with the socket security and authentication device and a user of the electronic device.

18. The method of claim 17, further comprising the step of providing on the display of the electronic device a message containing user instructions.

19. The method of claim 17, further comprising the step of providing, on the computer, authentication data generated from the method of claim 17, to a network.

20. The method of claim 17, further comprising the step of taking an action based on an outcome of the authentication step.
